(19) United States
(12) Patent Application Publication
(10) Pub. No.: US 2025/0041933 A1
(43) Pub. Date: Feb. 6, 2025

(54) ENHANCEMENT OF THERMAL CONDUCTIVITY OF ALUMINIUM BY DOPING GRAPHENE FOLLOWED BY MELTING AND CASTING PROCESS

(71) Applicants: INDIAN INSTITUTE OF TECHNOLOGY BHUBANESWAR, Bhubaneswar (IN); NATIONAL ALUMINIUM COMPANY LIMITED BHUBANESWAR, Bhubaneswar (IN)

(72) Inventors: Saroj Kumar Nayak, Bhubaneswar (IN); Bijoy Kumar Satpathy, Bhubaneswar (IN); Kedar Bhojak, Bhubaneswar (IN); Arijit Mitra, Bhubaneswar (IN); Subrat Kar, Bhubaneswar (IN); Binuta Patra, Bhubaneswar (IN); Aruna Kumar Sahu, Bhubaneswar (IN)

(21) Appl. No.: 18/713,426

(22) PCT Filed: Jan. 24, 2022
(86) PCT No.: PCT/IN2022/050053

§ 371 Date: May 24, 2024

(30) Foreign Application Priority Data
Nov. 26, 2021 (IN) 202131054790

(51) Int. Cl. B22D 21/00; B22D 27/00; B22D 27/15

(52) U.S. Cl. CPC B22D 21/007; B22D 27/003; B22D 27/15

(57) ABSTRACT

The present invention relates to the process for enhancement of thermal conductivity property of aluminium up to 50 to 90% or more by doping graphene or reduced graphene of two to five layers into aluminium by melting and casting process under inert or vacuum or atmospheric condition using salt and flux. Graphene with purity of 70 to 90% was incorporated into aluminium of any form for 30 to 120 minutes under inert atmosphere or vacuum at 700-900 deg C. Graphene of 0.1 to 5% weight of the total weight of aluminium has been used in the process. Under optimum conditions enhancement of thermal conductivity up to 80 to 90% has been observed using this process.

### CROSS-REFERENCE TO RELATED APPLICATION

The present application is a U.S. National Phase of International Application No. PCT/IN2022/050053, entitled “ENHANCEMENT OF THERMAL CONDUCTIVITY OF ALUMINIUM BY DOPING GRAPHENE FOLLOWED BY MELTING AND CASTING PROCESS” and filed Jan. 24, 2022, which claims priority to Indian Patent Application number 202131054790 filed on Nov. 26, 2021, the disclosure of both are incorporated herein by reference in their respective entireties.

### FIELD OF INVENTION

The present invention relates to a process for preparing aluminum-graphene composite material for an enhancement of thermal conductivity property. The invention further relates to the process for preparation of higher thermally conducting aluminium-graphene composite material, by innovative melting-casting process using aluminium and nano size graphene or reduced graphene oxide (rGO).

### BACKGROUND OF INVENTION

US20130000952A1 relates to a film of a conductive ceramic. Additives are at least partially incorporated into the film. The additives are at least one of electrically conductive and semiconducting and at least one of the additives has an aspect ratio of at least 3.

Whereas the present invention is not related to a transparent electrical conductor, its opaque material gives very high thermal conductivity. Further, the present invention is different as it is focusing on the process of amalgamation of aluminium metal of any form and reduced graphene oxide (or graphene) composite material prepared by melting followed by the innovative casting process, for significant increase in thermal conductivity (plus 80% more than pure aluminium). The extent of enhancement of thermal conductivity is dependent on the art of the synthesis process as well as composition.

Similarly, www.elsevier.comllocatelmsea relates to aluminium graphene composites with regard to strength and hardness. The paper concludes decrease in strength and hardness by incorporating graphene in aluminium due to formation of the carbides. Whereas the present invention is contrary to the conclusion of the published paper. The referred paper published in the journal mentions formation of carbide which makes the difference as of. The present invention is a process with superior control which blocks the formation of such carbides after a similar experience during the development of such process. Furthermore, the claims relate to the enhancement of the thermal conductivity property of pure Aluminium when composited with G or rGO under a special condition of melting and casting.

The journal of Structural and Mechanical Properties of Graphene reinforced Aluminium (Al) Matrix Composites, mentions about Aluminium and graphene oxide composite and enhancement of mechanical properties. Whereas the subject invention is having a composite material of Aluminium either with reduced Graphene Oxide or with Graphene and enhancement of thermal properties. Hence, such published journal is different from that of the subject application which is focusing on Thermal conductivity property. Moreover, the published research article relating to the effect of sintering time, temperature, and graphene addition on the hardness and microstructure of aluminium composites, which is also focusing on microstructure and hardness and not on the Thermal conductivity property.

Another article, the City University of London institutional repository mentioned the process which is entirely different from the present invention. It discusses the coating of graphene over the surface of aluminium metal following ultrasonic medium and focuses on the hardness of the produced material which is not the composite material. The present invention focuses on thermal conductivity property as well as distinct processes to produce composite materials of aluminium and graphene or reduced graphene oxide through melting and casting which is unique.

Thus, the present invention relates to the aluminium and graphene or reduced graphene oxide composite material to be produced using present novel melting and casting process to accrue the energy savings on account of the sharp rise in the thermal conductivity property by their applications.

Indian Application No. 201831047022 by the applicant relates to the process for enhancement of thermal conductivity of aluminium up to 75% by incorporating graphene of two to five layers at room temperature. Graphene with purity 99% plus was incorporated into nano size aluminium through powder sintering process at a temperature of 600-640 deg C. for 30-120 minutes under inert atmosphere. Graphene of 0.1 to 5% weight of aluminium has been used in the process. The sintered aluminium prepared was evaluated for its thermal conductivity and compared with pristine aluminium standard. Under optimum conditions enhancement of thermal conductivity up to 75% has been observed in this process. Similarly, the Vickers hardness number (micro hardness) for Al with G sintered product has been found to be enhanced by 25-35% by using 0.1 to 0.5% graphene with aluminium. Present invention is based on a different process achieving better thermal properties.

This application is different as it is following distinct powder sintering process. The present invention relates to a process for preparing aluminum-graphene composite material, by melting-casting using aluminium and nano size graphene or reduced graphene oxide (rGO) in presence/absence of salt blanket.

### OBJECTS OF THE INVENTION

The principal object of the present invention is to prepare the aluminium graphene composite material by melting, and casting process using aluminium and graphene or reduced graphene oxide.

Another object of the present invention is to provide a process for preparation of aluminium graphene composite material using aluminium of any size and graphene or reduced graphene oxide and completely melting them together.

Another object of the present invention is to provide a process for preparation of aluminium graphene composite material using molten aluminium and doping the graphene or reduced graphene oxide under special conditions of salt blanketing.

Yet another object of the present invention is to propose a process for preparation of aluminium graphene composite material which possess a higher thermal conductivity property along with the improved micro hardness.

Yet another object of the present invention is to provide a process for preparation of aluminium graphene composite by melting aluminium and graphene or reduced graphene oxide in the range of 700 to 900 deg C. either under vacuum or inert atmosphere with the aid of dedicated salts blanketing and fluxes addition followed by casting.

### SUMMARY OF THE INVENTION

Accordingly, the present invention is a process for preparation of high thermal conducting aluminium graphene or reduced graphene oxide composite materials, through melting casting process by doping of graphene or reduced graphene oxide into primary commercially available aluminium metal of any form with or without salt and flux, the process comprises the steps of:
i) doping of graphene or reduced graphene oxide nano to micro size aluminium metal of any sizes or form and charging to a controlled furnace under vacuum or argon surrounding atmosphere of the charge inside the furnace at 700 to 900 deg C. with or without salt and flux NaF blanketing,
ii) casting the molten mass into any prefabricated shaped and sized die or mould cavity either in inert or in vacuumed or atmospheric pressured condition of the environment surrounding of it when using salt and flux;
iii) cooling the temperature back to room temperature and preparing the cast composite materials to prepare the product.

The process uses the blanketing salts such as NaCl and KCl with flux (to avoid inert or vacuum medium). The flux used was NaF under atmospheric condition. The weight of salts used is 25% to 35% of total weight of the aluminium and graphene or reduced graphene oxide charge, and the ratio of the salts NaCl and KCl are 70:30. The fluxing material used is NaF of 5% to 15% of the total weight of the aluminium and graphene or optional reduced graphene oxide charge. In this process, the time of melting varied between 60 to 120 minutes under vacuum or argon atmosphere surrounding the charge inside the furnace with the heating rate of 5 to 10° C. per minute.

Further, the varying of weight percentage of graphene or reduced graphene oxide in the aluminium is from 0.1 to 5% of the total weight of aluminium. The graphene or reduced graphene oxide of average size is 2 to 50 nano meters with 2 to 5 layers of higher purity. The graphene used is of 2 to 5 layers with higher purity of 70 to 99%. The thermal conductivity of aluminium graphene composites is enhanced to 300 to 410 W/mK and even more with higher % of graphene.

### DETAILED DESCRIPTION OF THE PRESENT INVENTION

The detailed description of various exemplary embodiments of the disclosure is described herein. It should be noted that the embodiments are described herein in such details as to communicate the disclosure. However, the details provided herein is not intended to limit the anticipated variations of embodiments; on the contrary, the intention is to cover all modifications, equivalents, and alternatives falling within the scope of the present disclosure.

It is also to be understood that various substitutions/arrangements/permutations or combinations may be devised that, although not explicitly described or shown herein, embody the principles of the present disclosure. Moreover, all statements herein reciting principles, aspects, and embodiments of the present disclosure, as well as specific examples, are intended to encompass equivalents thereof.

The terminology used herein is to describe particular embodiments only and is not intended to be limiting of example embodiments. As used herein, the singular forms “a”, “an” and “the” are intended to include the plural forms as well, unless the context indicates otherwise. It will be further understood that the terms “comprise”, “comprising”, “includes” and/or “including” when used herein, specify the presence of stated features, steps, operations, elements and/or components, but do not preclude the presence or addition of one or more other features, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

The present invention relates to the methods where aluminium graphene or reduced graphene oxide composites are prepared by: doping of graphene or reduced graphene oxide of nano to micro size over and around the body of aluminium metal of any form with varied weight ratios to be kept within a ceramic container and charging them into a controlled furnace where increasing the temperature of such charge is to be carried out at a regulated manner of 5 to 10 deg C. per minute and maintaining at 700 to 900 deg C. for 60 to 120 minutes under vacuum or argon atmosphere with or without salt and fluxing material. Fluxing material NaF is used in the range of 5% to 15% of the total weight of the aluminium and graphene or reduced graphene oxide charge and the blanketing salts used are NaCl and KCl, with the combination of 70% and 30% by their weight respectively to have total weight of such combination in the range of 25% to 35% of the total weight of the aluminium and graphene or reduced graphene oxide charge. Salt and Flux are used to avoid inert or vacuum medium.

Then, casting the molten charge in a prefabricated die or mould cavity either in inert or in vacuumed or atmospheric pressured condition (using salt) followed by cooling the temperature back to room temperature and preparing the cast composite materials for further characterization. Casting of molten charge can be carried out with or without the addition of the salt and flux.

Graphene or reduced graphene oxide doped Aluminium composites as above exhibit up to 50 to 90% higher thermal conductivity compared to the original thermal conductivity of aluminium. The thermal conductivity is further increased with higher percentage of graphene and could be controlled by controlling the layer of graphene and its weight percentage.

The following process parameters were studied to synthesize the aluminium incorporated graphene composites
a) studied about primary available aluminium metal and commercially available aluminium
b) Graphene of 99% purity or reduced graphene oxide of higher purity of 2 to 5 layers having average thickness of 2 to10 nano meter
c) Melting method temperature varied from the range of 700 to 900 deg C. for 30 to 120 minutes with rate of heating 5 to 10 deg C. per minute.
d) Graphene percentage varied from 0.1 to 5% weight range of the total weight of aluminium
e) studied the effect of fluxing and salt percentage and inert/atmospheric

The typical characteristics of aluminium and graphene used in the process are given in Table-1 and Table-2 respectively.

The purpose of development of an innovative material using commercial grade aluminium or aluminium of different grain sizes and graphene or reduced graphene oxide and its synthesis following melting process and innovative casting under a set of process conditions to validate its application as highly thermally conducting material in solar thermal collector system, cooking system, conductors, heat exchangers etc. to replace the copper and other conventional materials. This will result the higher efficiency of the devices with cost improvement.

### EXAMPLES

The following examples illustrate the exact process for preparation of graphene or reduced graphene oxide doped aluminium composites:

### Example-1

Aluminium pieces with 3 weight % of graphene nano sizes along with 25% salt (NaCl and KCl in the ratio of 70:30) of the total weight of the aluminium and graphene or reduced graphene oxide charge taken in a high alumina ceramic container or alumina boat. The container with the material was charged to a furnace at 800 deg C. temperature for 120 minutes with heating rate of 10 deg C. per minute under argon surrounding atmosphere inside the furnace. The molten composite material was cast in the prefabricated die or mould cavity and cooled to room temperature. The cast product was analyzed to have a thermal conductivity of 390 W/mK at room temperature with micro vicker's hardness of 55.

### Example-2

Aluminium with 1.5% weight of graphene of 3-layer size of the total weight of aluminium was taken in an alumina container. The container with the material was charged to a furnace at 700 deg C. temperature for 90 minutes with heating rate of 10 deg C. per minute under argon surrounding atmosphere inside the furnace. The molten composite material was cast in to the mould in inert atmosphere and cooled to room temperature. The product was analysed to have a thermal conductivity of 305 W/mK at room temperature with micro vicker's hardness of 45.

TABLE 1
Typical Characteristics of Aluminium used

| Parameters | Value |
|---|---|
| Purity | 99.5% |
| Si | <0.15% |
| Fe | <0.35% |
| Melting Point | 660 deg C. |

TABLE 2
Typical Characteristics of Graphene used

| Parameters | Value | |
|---|---|---|
| Bulk density | 0.08 | g/cc |
| Diameter Average X &Y Dimensions | <5 | micron |
| Thickness Average Z Dimension | 2-5 | nm |
| Carbon Purity | >99% | |
| Number of Layers | Average, 2-5 | |
| Pore size | 0.34 nm-2 nm | |
| Carbon ash | <0.001% | |
| pH | 7 | |
| Surface Area | 330 | m²/g |

TABLE 3
Typical Characteristics of Aluminium
Graphene Composites Obtained

| Properties | Value |
|---|---|
| Quantitative distribution | Well distribution over the scan |
| of Al and Graphene in the | areas as evidenced from EDAX, |
| composite materials | EPMA and Raman mapping |
| Electrical conductivity of Al- | In the order of 10⁷ S/m |
| Graphene composite devices | |
| Thermal conductivity of Al- | Graphene doped into the |
| Graphene composite products | aluminium resulted into the |
| | enhanced thermal conductivity |
| | of the range from 200 to 400 |
| | W/mK with 0.25 to 3% by weight |
| | of the total weight of |
| | aluminium. |
| | The thermal conductivity depends |
| | on the quality of graphene or |
| | reduced graphene oxide, its weight |
| | % and purity of aluminium as |
| | thermal conductivity increases |
| | with higher % of graphene beyond 3%. |
| Micro-Hardness | 45 to 56 VHN (Vickers Hardness Number) |

It will be appreciated by those skilled in the art that the present invention can be embodied in other specific forms without departing from the essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

We claim:

1. Process for preparation of high thermal conducting aluminium graphene or reduced graphene oxide composite materials, through melting, and casting process by doping of graphene or reduced graphene oxide into aluminium metal of any form, the process comprises the steps of:
i) doping of graphene or reduced graphene oxide nano to micro size around aluminium metal and charging to a controlled furnace under argon surrounding atmosphere of the charge inside the furnace at 700 to 900 deg C. to melt the mass with or without salt and flux NaF;
ii) casting the molten mass into any prefabricated shaped and sized die or mould cavity either in inert or in vacuumed or atmospheric pressured condition using salt and flux.
iii) cooling the temperature back to room temperature and preparing the cast composite materials to prepare the product;
wherein the weight of salts is 25% to 35% of total weight of the aluminium and graphene or reduced graphene oxide charge.

2. The process as claimed in claim 1 where in the blanketing salts used are NaCl and KCl and flux used was NaF under atmospheric condition.

3. The process as claimed in claim 1 wherein the ratio of the salts NaCl and KCl are 70:30.

4. The process as claimed in claim 1 where in the fluxing material used is NaF of 5% to 15% of the total weight of the aluminium and graphene or reduced graphene oxide charge.

5. The process as claimed in claim 1 wherein the time of melting varied between 60 to 120 minutes under vacuum or argon atmosphere surrounding the charge inside the furnace with the heating rate of 5 to 10° C. per minute.

6. The process as claimed in claim 1 wherein the varying of weight percentage of graphene or reduced graphene oxide in the aluminium is from 0.1 to 5% of the total weight of aluminium.

7. The process as claimed in claim 1 wherein the graphene or reduced graphene oxide of average size is 2 to 50 nano meters with 2 to 5 layers of higher purity.

8. The process as claimed in claim 1, wherein the graphene is of 2 to 5 layers with higher purity of 70 to 99%.

9. The process as claimed in claim 1, wherein the thermal conductivity of aluminium graphene composites is enhanced to 300 to 410 W/mK and it increases with higher weight % of graphene.
